(19) United States
(12) Patent Application Publication
(10) Pub. No.: US 2001/0034709 A1
(43) Pub. Date: Oct. 25, 2001

(54) Anonymous and private browsing of web-sites through private portals

(76) Inventors: Salvatore J. Stoifo, Ridgewood, NJ (US); Jonathan Smith, Princeton, NJ (US)

Correspondence Address: PENNIE AND EDMONDS, 1155 AVENUE OF THE AMERICAS, NEW YORK, NY, 100362711

(21) Appl. No.: 09/795,839

(22) Filed: Feb. 28, 2001

Related U.S. Application Data
(60) Provisional application No. 60/185,655, filed on Feb. 29, 2000.

(51) Int. Cl. G06F 17/60

(52) U.S. Cl. 705/51

(57) ABSTRACT

A method and apparatus for enabling a user having a first identification at a first computer to communicate privately with a second computer. The method includes the step of receiving from the first computer a request to send a first message to the second computer, assigning a second identification to the user, and forwarding the first message to the second computer using the second identification. The method further includes the steps of receiving a second message from the second computer in response to the first message, and forwarding the second message to the first computer using the first identification. A corresponding system is also described.

### CROSS-REFERENCE TO RELATED APPLICATIONS

This application claims priority to U.S. Provisional Application No. 60/185,655 filed Feb. 29, 2000. A co-pending U.S. patent application Ser. No. 09/360,812, entitled “Electronic Purchase of Goods over a Communication Network Including Physical Delivery While Securing Private and Personal Information of the Purchasing Party” by Stolfo, et al., filed Jul. 26, 1999 is incorporated herein by reference.

### FIELD OF THE INVENTION

The present invention relates to a Web server configured to provide anonymous and private browsing of Web sites.

### BACKGROUND OF THE INVENTION

It is common practice today for retailers, merchants and marketers to collect data on users of the Internet, and to merge the collected data from multiple sources to “data mine” or learn about the users' identities and their private/personal information in order to target them for advertising or other purposes. Internet surfing habits of users are also gathered in order to “personalize” their Web experience.

Private information as used in the present invention is a broad concept. For instance, the private information may include name, email address, login name, postal address, IP address, phone number, financial information, “click stream” behavior, or purchasing behavior or other information attributable to individual users. To prevent the above described unwanted intrusion on privacy, a number of conventional Web servers provide anonymous Internet browsing features. Referring to FIG. 1, a user at a user computer 11 wishing to browse Web pages provided by a Web server 13 can first download a Web page provided by a conventional anonymous server computer 15. The user then can access the Web pages of Web server 13 through anonymous server computer 15 without revealing his/her true identity by using a proxy identification provided by anonymous server computer 15. However, in the conventional systems, Web server 13 cannot send any customized or individualized information back to the user. For instance, if Web server 13 provides research information on certain subjects not regularly available in the Web pages provided by Web server 13, then no such research data can be forwarded to the user because Web server 13 only has the proxy identification provided by anonymous server computer 15 but does not have the true identification to send such information to the user. Further, anonymous server computer 15 does not keep any information to map the proxy identification back to the true identification of its users. For the same reason, if the user wishes to purchase goods and/or services from the company operating Web server 13, the user either has to reveal his/her true identity to Web server computer 13 or cannot purchase the goods and/or services.

### SUMMARY OF THE INVENTION

The present invention provides for browsing Web pages provided by a Web server computer anonymously and privately. Further, the present invention allows messages to be exchanged between the user computer and the Web server computer. In particular, a trusted third party entity (i.e., a private portal server computer) registers true identity information of a user (e.g., e-mail addresses, IP address, URL, Web identification, etc.) and provides to the user a proxy identity for use when browsing the Web pages of the Web server computer. An example of a trusted third party is an accounting firm that may provide a legally binding and financially secured audit guarantee that the trusted third party will not disclose true identity information. The proxy identities may be retired or expunged when the user browses elsewhere after having extracted information from the Web server.

### BRIEF DESCRIPTION OF THE DRAWINGS

Preferred features of the present invention are disclosed in the accompanying drawings, wherein similar reference numbers denote similar elements throughout the several drawings, and wherein:

FIG. 1. is a diagram illustrating a conventional system for accessing a Web server computer anonymously;

FIG. 2 is a diagram illustrating the preferred system of privately accessing a Web server computer;

FIG. 3 is a diagram illustrating another preferred system of privately accessing a Web server computer; and

FIG. 4 is a diagram illustrating an identity bank of the present invention.

### DETAILED DESCRIPTION OF THE INVENTION

FIG. 2 depicts one or more user computers 101, one or more Web server computers 103 and a private portal server computer 107 that are interconnected by Internet 10. Private portal server computer 107 is a trusted third party. A user at user computer 101 can browse Web pages at Web server computer 103 anonymously and privately by sending a message to private portal computer 107 requesting that the Web pages at Web server computer 103 be downloaded to user computer 101. The request is made by user computer 101 using a true identification of the user (e.g., e-mail addresses, IP addresses, URL, Web identifications, etc.). Further, the message is written in a browser language such as hypertext markup language (HTML), extensible markup language (XML) or other browser language available to one of ordinary skill in the art.

Upon receiving the message, portal server 107 assigns a proxy identification to the user using an identity bank 109. In particular, identity bank 109 maintains a table that matches identifications of many users and proxy identifications. Moreover, identity bank 109 provides for prompt retrieval of one type of identification in response to entry of the other type of identification. After a proxy identification has been assigned to the message from user computer 101, portal server 107 forwards the message to Web server 103 using the proxy identification. Once the above links are established among user computer 101, portal server computer 107 and Web server computer 103, the Web pages of Web server computer 103 can be browsed by the user anonymously. Further, additional messages can be exchanged among them.

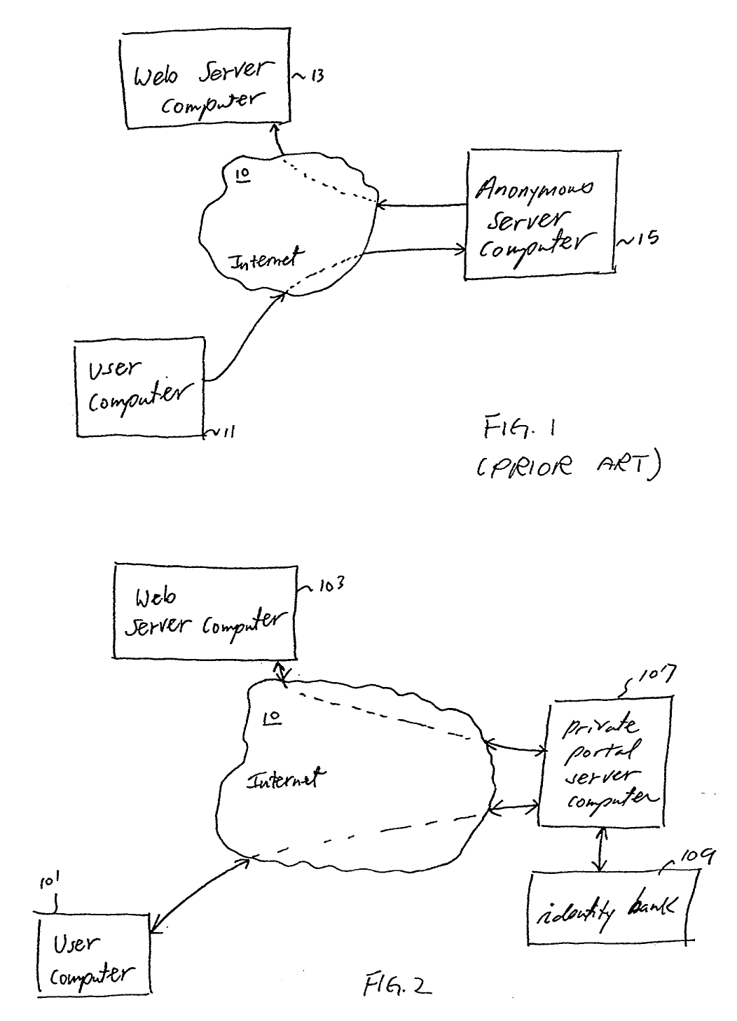

Unlike the conventional system described above in connection with FIG. 1, the system described in FIG. 2 allows messages to be sent from Web server computer 103 to user computer 101 using the proxy identification. More specifically, messages from Web server 103 using the proxy identification as the messages' destination address are forwarded to portal server 107. At portal server 107, the proxy identifications are replaced with the true user identifications based on information stored in identity bank 109. After this replacement, the messages are then forwarded to user computer 101 using the true user identification as the destination address. The messages from Web server 103 generated based on the request from the user may include research information on certain subjects not regularly available in the Web pages provided by Web server 103. More examples of these types of customized private messages are discussed later.

It should be noted that the above discussed system allows the user to remain anonymous while allowing the user to receive private messages from Web server 103.

It should also be noted that providing access to Web server 103 via private portal server 107 involves not only assigning proxy identities to users but also certifying that Web server 103 is visited anonymously. Thus, the trusted third party (i.e., portal server 107) has a trust relationship with the user and the company operating Web server 103. However, there is no such trust relationship between the user and the company operating Web server 103. Furthermore, the trusted third party (i.e., portal server 107) retains sufficient information about the true identity of the user so that any subsequent transaction can be accomplished readily between the user and Web server 103, using standard transaction media (e.g., credit cards).

Private portal 107 is preferably implemented by a combination of existing technologies, and preferably requires no change to the form, structure and content of the Web pages of Web server 103. In one exemplary embodiment, the private portal server 107 includes an anonymizing server (e.g., Anonymizer.com) or other anonymizing services commonly known in the art and identity bank 109.

In another embodiment, a user may directly access the Web site without first downloading web pages from the trusted third party. For instance, a user may access a Web page of www.irs.gov privately simply by browsing at www.private.irs.gov (or alternatively, www.irs.private.gov), an address maintained at private portal server 107 which passes the user's browser Web request through private portal server 107 on its way to the IRS' Web site after the browser request has been anonymized (e.g., provided with a proxy identity). In fact, a user does not need to know whether a Web site he/she wishes to browse has a private portal or not. By using URL “name space” is such a general way, a user can simply type in www.private.XXX.com (or alternatively, www.XXX.private.com) and if a private portal does indeed exist, it would be automatically accessed by the user's Web browser. There would be no particular need to advertise the existence of the private portal if a standard private portal name as suggested here is used by each Web site provider.

In yet another embodiment, the private portal server service is preferably provided as a front end to an existing Web server (commercial or other) offering services or information to users of the Web. In other words, the “private portal” preferably offers specific features and functions provided by Web server 103, and serves as a private entry point to the Web site provider for customers who may want to remain anonymous. Thus, private portal server 107 can be easily and conveniently implemented on the World Wide Web at any Web site that wishes to provide a private portal to its particular Web site. It should be emphasized that the private portal server 107 does not provide a general Web site that users may pass through when visiting any other Web site. Server 107 is specific and specialized to a distinct Web site; it is not a single server that handles all Web sites (i.e., www.anonymizer.com).

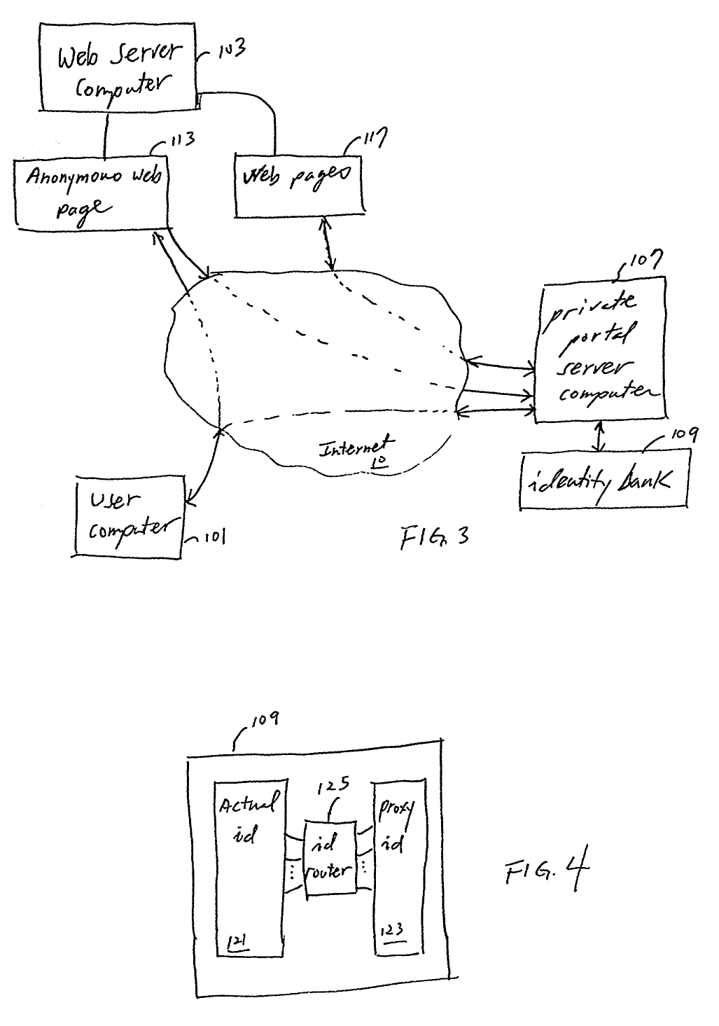

More specifically, Web server 103 itself provides an option to browse its Web pages anonymously and privately. Referring to FIG. 3, a user at user computer 101 wishing to access Web pages 111 provided by Web server computer 103 preferably first downloads an anonymous access Web page 113 (this can be in the form of a button or label in one of the regular Web pages). This feature sends the request from user computer 101 to private portal server computer 107. Upon receiving the message, portal server 107 assigns a proxy identification to the user identification. Portal server 107 then forwards the message to Web server 103 using the proxy identification. Once the above links are established among user computer 101, portal server computer 107 and Web server computer 103, Web pages 111 can be browsed by the user anonymously. Further, more messages can be exchanged among them.

In addition, private portals of the present invention can be designed and created for a number of separate Web site providers who have a strategic alliance or business relationship with each other, each providing a common private entry point to their individual Web sites. For example, a “shopping mall” may provide a single private portal from which any of the e-merchants inside the “e-mall” may be accessed.

Referring to FIG. 4, identity bank 109 includes one or more databases. In particular, identity bank 109 includes a database 121 that stores true user identifications and a database 123 that stores proxy identifications. It should be noted that the proxy identification is constantly updated as discussed above. Further, the proxy identifications are generated by a random identification generator. The true user identifications are assigned to the randomly generated proxy identifications by an ID router 125 which constantly updates the assignments. Alternatively, another trusted entity, other than the trusted third party maintaining private portal server 107, may actually hold the true user identifications and only provide an identification number or code to private portal server 107 to which a proxy identity is assigned. In this variation, identity bank 109 would hold only the proxy identifications and their corresponding identification codes, not the actual identification information, so that the trusted third party maintaining private portal server 107 assumes no liability for disclosing true user identifications.

By using the random identification generator a completely new proxy identity can be created upon each visit by any user. Alternatively, the randomly generated proxy identities are reused by different users. Thus, time correlated behavior information about a particular user is prevented. Note that in conventional systems when a proxy identity is purchased from some supplier for general use over the Internet, it is possible to track a specific user via their proxy identity over time.

Moreover, the present invention preferably does not require a user to purchase a proxy identity from any other party that he or she may then use at an arbitrary Web site. Upon visiting the private portal for any Web site, a user is automatically assigned a new proxy identity to use for as short a time as the user wishes. No purchase of proxy identities is needed. In addition, the Web site provider can tailor the user's private portal experience to suit his or her own business needs for the user experience they wish to provide.

However, in an alternative embodiment, a user may register a long-term proxy identity with the trusted third party so that the Web site may from time to time contact the anonymous user via a proxy email address assigned by the trusted third party.

It should be noted that the above described features of the trusted third party are preferably implemented in computer executable software programs. For instance, the features of generating proxy identities, forwarding and receiving messages to and from the user computer and the Web server, and mapping the true identities to the proxy identities are preferably implemented in computer executable programs.

The following examples discuss various embodiments of how the present invention can be utilized.

An investment banking or brokerage organization may provide a Web site where “research information” is provided to any user of the World Wide Web. Some parties who may be interested in that information are themselves large institutional investors whose market activities may be of particular interest to the brokerage organization providing the research information. The large institutional investor may be inhibited from accessing the brokerage Web site for fear of tipping off the brokerage firm on important stock market activities that may be performed by the institutional investor. It is therefore advantageous to the large institutional investor to remain anonymous from the brokerage Web site when it accesses research information. It is also advantageous for the brokerage firm to provide a private portal as access to its Web site so that its research information is readily available to any interested user who may otherwise be so distrustful as to ignore the Web site in the first place.

Another example teaches the value of the invention disclosed herein. Suppose an auction service (e.g., Sotheby's) is provided online allowing user's to inspect items available for auction, and to submit bids anonymously. For example, if an auction house or other bidders became aware that the Metropolitan Museum of Modem Art was bidding on a particular art item, the price of the item could be bid up substantially, preventing the museum from participating in the first place.

Another example is a user who wishes to learn about tax case law in order to prepare his or her income tax filing for the Internal Revenue Service. A user may be hesitant to disclose any of his or her private information to the IRS while seeking information. In general, a private portal to a government Web site would provide for accessing public information from government sources without the threat of disclosing a citizen's true identity to that agency.

In still another example, a user who wishes to browse information on medical Web sites, such as information relating to medical devices and prescription medications, may not wish to disclose his or her identity to the entity maintaining the Web site. In addition, the recent Health Insurance Portability and Accountability Act of 1996 (HIPAA) lays out strict procedures for the protection of all individually identifiable health information that is or has been electronically transmitted. A private portal to a medical Web site would protect against the unauthorized collection and dissemination of a user's health-related information. Further, since HIPAA allows for the “reidentification” of medical records and information in some cases, an identity map of user identities held by a trusted third party could be used to “reidentify” an individual user pursuant to HIPAA.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the claims as allowed.

What is claimed is:

1. A method of allowing a user at a first computer to communicate privately with a second computer, comprising:
receiving a request from the first computer to send a first message to the second computer, wherein the user has a first identification;
assigning a second identification to the user;
forwarding the first message to the second computer using the second identification;
receiving a second message from the second computer, wherein the second message includes customized information generated in response to the first message; and
forwarding the second message to the first computer using the first identification.

2. The method according to claim 1 wherein the step of assigning the second identification further comprises:
randomly generating a second identification.

3. The method according to claim 1 wherein the second message is an e-mail message.

4. The method according to claim 1 further comprising:
providing at least one of auction house services, brokerage firm services, investment banking services, governmental services and accounting firm services using the second computer.

5. The method according to claim 1 wherein the first message is written in a browser language.

6. The method according to claim 5 wherein the browser language is one of Hypertext Markup Language (HTML) and Extensible Markup Language (XML).

7. A system of allowing a user at a first computer to communicate privately with a second computer, comprising:
a server computer including:
a communication device configured to receive a request to send a first message to the second computer, wherein the user has a first identification; and
a processor configured to assign a second identification to the user, wherein the communication device is further configured to forward the first message to the second computer using the second identification, configured to receive a second message from the second computer and configured to forward the second message to the first computer using the first identification, wherein the second message includes customized information generated in response to the first message.

8. The system according to claim 7 the server further comprising:
an identification generator configured to generate randomly a plurality of second identifications.

9. The system according to claim 7 wherein the server is configured to provide at least one of auction house services, brokerage firm services, investment banking services, governmental services and accounting firm services using the second computer.

10. A software program implemented in a computer system for allowing a user at a first computer to communicate privately with a second computer, said software program configuring the computer system to:
receive a request from the first computer to send a first message to the second computer, wherein the user has a first identification;
assign a second identification to the user;
forward the first message to the second computer using the second identification;
receive a second message from the second computer, wherein the second message includes customized information generated in response to the first message; and
forward the second message to the first computer using the first identification.

11. The software according to claim 10 further configuring the computer system to:
randomly generate a second identification.

12. The software according to claim 11 wherein the second message is an e-mail message.

13. The software according to claim 10 further configuring the computer system to:
provide at least one of auction house services, brokerage firm services, investment banking services, governmental services and accounting firm services using the second computer.

14. The software according to claim 10 wherein the first message is written in a browser language.

15. The software according to claim 14 wherein the browser language is one of Hypertext Markup Language (HTML) and Extensible Markup Language (XML).
